(19) United States
(12) Patent Application Publication
(10) Pub. No.: US 2009/0070402 A1
(43) Pub. Date: Mar. 12, 2009

(54) SYSTEMS, METHODS, AND APPARATUS FOR A DISTRIBUTED NETWORK OF QUANTUM COMPUTERS

(76) Inventors: Geordie Rose, Vancouver (CA); Eugene Dantsker, San Diego, CA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/195,300

(22) Filed: Aug. 20, 2008

Related U.S. Application Data
(60) Provisional application No. 60/971,502, filed on Sep. 11, 2007.

(51) Int. Cl. G06F 15/16

(52) U.S. Cl. 709/201

(57) ABSTRACT

A problem solving system includes a number of special-purpose computers including at least one quantum computer. Problems are decomposed into sub-problems and routed to one of the special-purpose computers based on the problem class to which the problem belongs. Sub-solutions produced by the special-purpose computers are complied to produce at least an approximate solution to the problem.

### CROSS REFERENCE TO RELATED APPLICATIONS

This application claims benefit under 35 U.S.C. 119(e) of U.S. Provisional Patent Application Ser. No. 60/971,502, filed Sep. 11, 2007, entitled “Systems, Methods, and Apparatus for a Distributed Network of Quantum Computers”, which is incorporated herein by reference in its entirety.

### BACKGROUND

1. Field

The present systems, methods, and apparatus relate to computer systems that comprise a network of special-purpose computers including at least one quantum computer.

2. Description of the Related Art

A Turing machine is a theoretical computing system, described in 1936 by Alan Turing. A Turing machine that can efficiently simulate any other Turing machine is called a Universal Turing Machine (UTM). The Church-Turing thesis states that any practical computing model has either the equivalent or a subset of the capabilities of a UTM.

A quantum computer is any physical system that harnesses one or more quantum effects to perform a computation. A quantum computer that can efficiently simulate any other quantum computer is called a Universal Quantum Computer (UQC).

In 1981 Richard P. Feynman proposed that quantum computers could be used to solve certain computational problems more efficiently than a UTM and therefore invalidate the Church-Turing thesis. See e.g., Feynman R. P., “Simulating Physics with Computers”, International Journal of Theoretical Physics, Vol. 21 (1982) pp. 467-488. For example, Feynman noted that a quantum computer could be used to simulate certain other quantum systems, allowing exponentially faster calculation of certain properties of the simulated quantum system than is possible using a UTM.

### Approaches to Quantum Computation

There are several general approaches to the design and operation of quantum computers. One such approach is the “circuit model” of quantum computation. In this approach, qubits are acted upon by sequences of logical gates that are the compiled representation of an algorithm. Circuit model quantum computers have several serious barriers to practical implementation. In the circuit model, it is required that qubits remain coherent over time periods much longer than the single-gate time. This requirement arises because circuit model quantum computers require operations that are collectively called quantum error correction in order to operate. Quantum error correction cannot be performed without the circuit model quantum computer's qubits being capable of maintaining quantum coherence over time periods on the order of 1,000 times the single-gate time. Much research has been focused on developing qubits with coherence sufficient to form the basic information units of circuit model quantum computers. See e.g., Shor, P. W. “Introduction to Quantum Algorithms”, arXiv.org:quant-ph/0005003 (2001), pp. 1-27. The art is still hampered by an inability to increase the coherence of qubits to acceptable levels for designing and operating practical circuit model quantum computers.

Another approach to quantum computation involves using the natural physical evolution of a system of coupled quantum systems as a computational system. This approach does not make critical use of quantum gates and circuits. Instead, starting from a known initial Hamiltonian, it relies upon the guided physical evolution of a system of coupled quantum systems wherein the problem to be solved has been encoded in the terms of the system's Hamiltonian, so that the final state of the system of coupled quantum systems contains information relating to the answer to the problem to be solved. This approach does not require long qubit coherence times. Examples of this type of approach include adiabatic quantum computation, cluster-state quantum computation, one-way quantum computation, quantum annealing and classical annealing, and are described, for example, in Farhi, E. et al., “Quantum Adiabatic Evolution Algorithms versus Simulated Annealing” arXiv.org:quant-ph/0201031 (2002), pp 1-16.

### Qubits

As mentioned previously, qubits can be used as fundamental units of information for a quantum computer. As with bits in UTMs, qubits can refer to at least two distinct quantities; a qubit can refer to the actual physical device in which information is stored, and it can also refer to the unit of information itself, abstracted away from its physical device. Examples of qubits include quantum particles, atoms, electrons, photons, ions, and the like.

Qubits generalize the concept of a classical digital bit. A classical information storage device can encode two discrete states, typically labeled “0” and “1”. Physically these two discrete states are represented by two different and distinguishable physical states of the classical information storage device, such as direction or magnitude of magnetic field, current, or voltage, where the quantity encoding the bit state behaves according to the laws of classical physics. A qubit also contains two discrete physical states, which can also be labeled “0” and “1”. Physically these two discrete states are represented by two different and distinguishable physical states of the quantum information storage device, such as direction or magnitude of magnetic field, current, or voltage, where the quantity encoding the bit state behaves according to the laws of quantum physics. If the physical quantity that stores these states behaves quantum mechanically, the device can additionally be placed in a superposition of 0 and 1. That is, the qubit can exist in both a “0” and “1” state at the same time, and so can perform a computation on both states simultaneously. In general, N qubits can be in a superposition of 2^{N} states. Quantum algorithms make use of the superposition property to speed up some computations.

In standard notation, the basis states of a qubit are referred to as the |0> and |1> states. During quantum computation, the state of a qubit, in general, is a superposition of basis states so that the qubit has a nonzero probability of occupying the |0> basis state and a simultaneous nonzero probability of occupying the |1> basis state. Mathematically, a superposition of basis states means that the overall state of the qubit, which is denoted |Ψ [symbol] , has the form |Ψ [symbol] =a|0 [symbol] +b|1 [symbol] , where a and b are coefficients corresponding to the probabilities |a|² and |b|², respectively. The coefficients a and b each have real and imaginary components, which allows the phase of the qubit to be characterized. The quantum nature of a qubit is largely derived from its ability to exist in a coherent superposition of basis states and for the state of the qubit to have a phase. A qubit will retain this ability to exist as a coherent superposition of basis states when the qubit is sufficiently isolated from sources of decoherence.

To complete a computation using a qubit, the state of the qubit is measured (i.e., read out). Typically, when a measurement of the qubit is performed, the quantum nature of the qubit is temporarily lost and the superposition of basis states collapses to either the |0> basis state or the |1> basis state and thus regaining its similarity to a conventional bit. The actual state of the qubit after it has collapsed depends on the probabilities |a|² and |b|² immediately prior to the readout operation.

### Superconducting Qubits

There are many different hardware and software approaches under consideration for use in quantum computers. One hardware approach uses integrated circuits formed of superconducting materials, such as aluminum or niobium. The technologies and processes involved in designing and fabricating superconducting integrated circuits are similar in some respects to those used for conventional integrated circuits.

Superconducting qubits are a type of superconducting device that can be included in a superconducting integrated circuit. Typical superconducting qubits, for example, have the advantage of scalability and are generally classified depending on the physical properties used to encode information including, for example, charge and phase devices, phase or flux devices, hybrid devices, and the like. Superconducting qubits can be separated into several categories depending on the physical property used to encode information. For example, they may be separated into charge, flux and phase devices, as discussed in, for example Makhlin et al., 2001, Reviews of Modern Physics 73, pp. 357-400. Charge devices store and manipulate information in the charge states of the device, where elementary charges consist of pairs of electrons called Cooper pairs. A Cooper pair has a charge of 2e and consists of two electrons bound together by, for example, a phonon interaction. See e.g., Nielsen and Chuang, Quantum Computation and Quantum Information, Cambridge University Press, Cambridge (2000), pp. 343-345. Flux devices store information in a variable related to the magnetic flux through some part of the device. Phase devices store information in a variable related to the difference in superconducting phase between two regions of the phase device. Recently, hybrid devices using two or more of charge, flux and phase degrees of freedom have been developed. See e.g., U.S. Pat. No. 6,838,694 and U.S. Pat. No. 7,335,909.

Examples of flux qubits that may be used include rf-SQUIDs, which include a superconducting loop interrupted by one Josephson junction, or a compound junction (where a single Josephson junction is replaced by two parallel Josephson junctions), or persistent current qubits, which include a superconducting loop interrupted by three Josephson junctions, and the like. See e.g., Mooij et al, 1999, Science 285, 1036; and Orlando et al, 1999, Phys. Rev. B 60, 15398. Other examples of superconducting qubits can be found, for example, in Il'ichev et al., 2003, Phys. Rev. Lett. 91, 097906; Blatter et al., 2001, Phys. Rev. B 63, 174511, and Friedman et al., 2000, Nature 406, 43. In addition, hybrid charge-phase qubits may also be used.

The qubits may include a corresponding local bias device. The local bias devices may include a metal loop in proximity to a superconducting qubit that provides an external flux bias to the qubit. The local bias device may also include a plurality of Josephson junctions. Each superconducting qubit in the quantum processor may have a corresponding local bias device or there may be fewer local bias devices than qubits. In some embodiments, charge-based readout and local bias devices may be used. The readout device(s) may include a plurality of dc-SQUID magnetometers, each inductively connected to a different qubit within a topology. The readout device may provide a voltage or current. DC-SQUID magnetometers typically include a loop of superconducting material interrupted by at least one Josephson junction.

### Superconducting Quantum Processor

A computer processor may take the form of an analog processor, for instance a quantum processor such as a superconducting quantum processor. A superconducting quantum processor may include a number of qubits and associated local bias devices, for instance two or more superconducting qubits. Further detail and embodiments of exemplary superconducting quantum processors that may be used in conjunction with the present systems, methods, and apparatus are described in US Patent Publication No. 2006-0225165, U.S. patent application Ser. No. 12/013,192, U.S. Provisional Patent Application Ser. No. 60/986,554 filed Nov. 8, 2007 and entitled “Systems, Devices and Methods for Analog Processing,” and U.S. Provisional Patent Application Ser. No. 61/039,710, filed Mar. 26, 2008 and entitled “Systems, Devices, And Methods For Analog Processing.”

A superconducting quantum processor may include a number of coupling devices operable to selectively couple respective pairs of qubits. Examples of superconducting coupling devices include rf-SQUIDs and dc-SQUIDs, which couple qubits together by flux. SQUIDs include a superconducting loop interrupted by one Josephson junction (an rf-SQUID) or two Josephson junctions (a dc-SQUID). The coupling devices may be capable of both ferromagnetic and anti-ferromagnetic coupling, depending on how the coupling device is being utilized within the interconnected topology. In the case of flux coupling, ferromagnetic coupling implies that parallel fluxes are energetically favorable and anti-ferromagnetic coupling implies that anti-parallel fluxes are energetically favorable. Alternatively, charge-based coupling devices may also be used. Other coupling devices can be found, for example, in U.S. Patent Publication Number 2006-0147154 and U.S. patent application Ser. No. 12/017,995. Respective coupling strengths of the coupling devices may be tuned between zero and a maximum value, for example, to provide ferromagnetic or anti-ferromagnetic coupling between qubits.

### OTHER EMBODIMENTS OF QUANTUM COMPUTERS

A quantum computer is any computing device that makes direct use of quantum mechanical phenomena, such as superposition and entanglement, to solve computational problems. To date, many different systems have been proposed and studied as physical realizations of quantum computers. Examples of such systems include the following devices: ion traps, quantum dots, harmonic oscillators, cavity quantum electrodynamics devices (QED), photons and nonlinear optical media, heteropolymers, cluster-states, anyons, topological systems, systems based on nuclear magnetic resonance (NMR), and systems based on spins in semiconductors. For further background on these systems, see Nielsen and Chuang, Quantum Computation and Quantum Information, Cambridge University Press, Cambridge (2000), pp. 277-352; Williams and Clearwater, Explorations in Quantum Computing, Springer-Verlag, New York, Inc. (1998), pp. 241-265; Nielsen, Micheal A., “Cluster-State Quantum Computation”, arXiv.org:quant-ph/0504097v2 (2005), pp 1-15; and Brennen, Gavin K. et al., “Why should anyone care about computing with anyons?”, arXiv.org:quant-ph/0704.2241 (2007), pp 1-19.

In brief, an example of an ion trap quantum computer is a computer structure that employs ions that are confined in free space using electromagnetic fields. Qubits may be represented by the stable electronic states of each ion. An example of a quantum dot quantum computer is a computer structure that employs electrons that have been confined to small regions where their energies can be quantized in such a way that each dot may be isolated from the other dots. An example of a harmonic oscillator is computer structure that employs a particle in a parabolic potential well. An example of a photonic quantum computer is a computer structure in which qubits are represented by individual photons which may be manipulated using beam-splitters, polarization filters, phase shifters, and the like. An example of an optical quantum computer is a photonic quantum computer that implements optical photons. An example of a cavity QED quantum computer is a computer structure that employs single atoms within optical cavities where the single atoms are coupled to a limited number of optical modes. An example of an NMR quantum computer is a computer structure in which qubits are encoded in the spin states of at least one of the nuclei in the atoms comprising a molecular sample. An example of a heteropolymer quantum computer is a computer structure that employs a linear array of atoms as memory cells, where the state of the atoms provides the basis for a binary arithmetic. An example of a quantum computer that uses electron spins in semiconductors is the Kane computer, in which donor atoms are embedded in a crystal lattice of, for example, silicon. An example of a topological quantum computer is a computer structure that employs two-dimensional “quasiparticles” called anyons whose world lines cross to form braids in a three-dimensional spacetime. These braids may then be used as the logic gates that make up the computer structure. Lastly, an example of a cluster-state quantum computer is a computer structure that employs a plurality of qubits that have been entangled into one quantum state, referred to as a cluster-state. “Cluster-state” generally refers to a particular quantum computing method, and those of skill in the art will appreciate that the present systems, methods and apparatus may incorporate all forms of quantum computing, including the various hardware implementations and algorithmic approaches. Those of skill in the art will also appreciate that the descriptions of various embodiments of quantum computers provided herein are intended only as examples of some different physical realizations of quantum computation. The present systems, methods and apparatus are in no way limited by or to these descriptions. Those of skill in the art will also appreciate that a quantum computer may be embodied in a system other than those described above. The present systems, methods and apparatus describe a distributed network of special-purpose including at least one quantum computer, where the physical embodiment(s) of the quantum computer(s) may depend on the particular embodiment of the present systems, methods and apparatus.

### Special-Purpose Computers

A special-purpose computer is any computing device that has been specifically designed to solve a particular type of problem, or a limited set of types of problems. Such devices are in contrast with general-purpose computers, which are designed to handle a broad range of problems, and universal computers, which in theory can handle any computable problem. A special-purpose computing system may exhibit enhanced efficiency in solving a problem from a prescribed subset of problems. However, such efficiency typically comes at the expense of yielding poor results for problems outside of the subset of problems. Implementing special-purpose computers may be advantageous when solving problems that are particularly hard, as in such cases the enhanced efficiency may have its greatest impact.

### Computational Complexity Theory

In computer science, computational complexity theory is the branch of the theory of computation that studies the resources, or cost, of the computation required to solve a given computational problem. This cost is usually measured in terms of abstract parameters such as time and space, called computational resources. Time represents the number of steps required to solve a problem and space represents the quantity of information storage required or how much memory is required.

Computational complexity theory classifies computational problems into complexity classes. The number of complexity classes is ever changing, as new ones are defined and existing ones merge through the contributions of computer scientists. The complexity classes of decision problems include:
1. P—The complexity class containing decision problems that can be solved by a deterministic UTM using a polynomial amount of computation time;
2. NP (“Non-deterministic Polynomial time”)—The set of decision problems solvable in polynomial time on a non-deterministic UTM. Equivalently, it is the set of problems that can be “verified” by a deterministic UTM in polynomial time;
3. NP-hard (Nondeterministic Polynomial-time hard)—A problem H is in the class NP-hard if and only if there is an NP-complete problem L that is polynomial time Turing-reducible to H. That is to say, L can be solved in polynomial time by an oracle machine with an oracle for H;
4. NP-complete—A decision problem C is NP-complete if it is complete for NP, meaning that:
   (a) it is in NP and
   (b) it is NP-hard,
i.e., every other problem in NP is reducible to it. “Reducible” means that for every problem L, there is a polynomial-time many-one reduction, a deterministic algorithm which transforms instances IεL into instances cεC, such that the answer to c is YES if and only if the answer to I is YES. To prove that an NP problem A is in fact an NP-complete problem it is sufficient to show that an already known NP-complete problem reduces to A.

In addition, there exists a wide range of “quantum” complexity classes that account for quantum-based approaches to problem solving. Full descriptions of these classes are provided online at Complexity Zoo, http://qwiki.caltech.edu/wiki/Complexity_Zoo.

Decision problems have binary outcomes. Problems in NP are computation problems for which there exists a polynomial time verification. That is, it takes no more than polynomial time (class P) in the size of the problem to verify a potential solution. It may take more than polynomial time, however, to find a potential solution. NP-hard problems are at least as hard as any problem in NP.

Optimization problems are problems for which one or more objective functions are minimized or maximized over a set of variables, sometimes subject to a set of constraints. For example, the Traveling Salesman Problem (“TSP”) is an optimization problem where an objective function representing, for example, distance or cost, must be optimized to find an itinerary, which is encoded in a set of variables representing the optimized solution to the problem. For example, given a list of locations, the problem may consist of finding the shortest route that visits all locations exactly once. Other examples of optimization problems include Maximum Independent Set, integer programming, constraint satisfaction, factoring, prediction modeling, and k-SAT. These problems are abstractions of many real-world optimization problems, such as operations research, financial portfolio selection, scheduling, supply management, circuit design, and travel route optimization. Many large-scale decision-based optimization problems are NP-hard. See e.g., “A High-Level Look at Optimization: Past, Present, and Future” e-Optimization.com, 2000.

Simulation problems typically deal with the simulation of one system by another system, usually over a period of time. For example, computer simulations can be made of business processes, ecological habitats, protein folding, molecular ground states, quantum systems, and the like. Such problems often include many different entities with complex inter-relationships and behavioral rules. In Feynman it was suggested that a quantum system could be used to simulate some physical systems more efficiently than a UTM.

Many optimization and simulation problems are not solvable using UTMs. Because of this limitation, there is need in the art for computational devices capable of solving computational problems beyond the scope of UTMs. In the field of protein folding, for example, grid computing systems and supercomputers have been used to try to simulate large protein systems. See Shirts et al., 2000, Science 290, pp. 1903-1904, and Allen et al., 2001, IBM Systems Journal 40, p. 310. The NEOS solver is an online network solver for optimization problems, where a user submits an optimization problem, selects an algorithm to solve the problem, and then a central server directs the problem to a computer in the network capable of running the selected algorithm. See e.g., Dolan et al., 2002, SIAM News Vol. 35, p. 6. Other digital computer-based systems and methods for solving optimization problems can be found, for example, in Fourer et al., 2001, Interfaces 31, pp. 130-150. All these methods are limited, however, by the fact they utilize digital computers, which are UTMs, and accordingly, are subject to the limits of classical computing that impose unfavorable scaling between problem size and solution time.

### BRIEF SUMMARY

At least one aspect may be summarized as a computing system including an operating system including at least one classical computer; a plurality of special-purpose computers of which at least one is a quantum computer; and a communication network that includes a plurality of communication conduits wherein at least one communication conduit communicates between the operating system and at least one of the special-purpose computers.

The quantum computer may take the form of an ion trap quantum computer, a quantum dot quantum computer, a nuclear magnetic resonance quantum computer, a semiconductor-based quantum computer, an optical quantum computer, a photonic quantum computer, a superconducting quantum computer, a circuit model quantum computer, an adiabatic quantum computer, a topological quantum computer, an anyon-based quantum computer, a quantum computer based on cavity quantum electrodynamic devices, a harmonic oscillator, and/or a cluster-state quantum computer. The quantum computer may be a special-purpose quantum computer that solves a particular class of problems. The quantum computer may solve problems from at least one problem class selected from the group consisting of: P problems, NP problems, NP-hard problems, NP-complete problems, QMA problems, QMA-complete problems, BQP problems, and QIP problems. The quantum computer may solve problems from at least one problem class selected from the group consisting of: integer programming problems, mixed integer programming problems, optimization problems, simulation problems, constraint satisfaction problems, prediction modeling problems, k-SAT problems, and maximum independent set problems. The at least one communication conduit may take the form of conventional electrical cables, printed circuit boards, superconducting wires, radio signals, single-flux quantum transmission lines, wi-fi, fiber-optic cables, and/or qubit couplers. The at least one communication conduit may provide communications between at least two respective special-purpose computers. The communication network may include at least one quantum communication channel. The computing system may include at least two quantum computers and the communication network may include at least one quantum communication channel between the at least two quantum computers. The at least one quantum communication channel may support a transmission of quantum information. The at least one quantum communication channel may support quantum communications via entanglement. The at least one special-purpose computer may take the form of a classical special-purpose computer based on FPGA, a classical special-purpose computer based on ASICs, an analog computer, a wind tunnel system, and/or a conventional general-purpose computer.

At least one aspect may be summarized as a method of problem solving on a system of networked computers including decomposing a problem into a set of sub-problems; identifying a problem class of each sub-problem; transmitting the set of sub-problems to a network of special-purpose computers that includes at least one quantum computer, wherein at least a first one of the special-purpose computers solves problems from at least a first one of the problem classes in the set of problem classes at least more effectively than at least a second one of the special-purpose computers in the network of special-purpose computers; for each of at least some of the sub-problems in the set of sub-problems, automatically routing the sub-problem to the at least one of the special-purpose computers in the network of special-purpose computers that is most effective at solving problems from the identified problem class to which the sub-problem belongs; and for each of at least some of the sub-problems, solving the sub-problem on the special-purpose computer in the network of special-purpose computers to which the sub-problem was routed.

The method may further include returning solutions to the sub-problems from the special-purpose computers to produce a set of sub-solutions; and compiling the set of sub-solutions to produce at least an approximate solution to the problem. Identifying a problem class of each sub-problem may include identifying the problem class of each sub-problem from a set of problem classes selected from the group consisting of: P problems, NP problems, NP-hard problems, NP-complete problems, QMA problems, QMA-complete problems, BQP problems, and QIP problems. Identifying a problem class of each sub-problem may include identifying the problem class of each sub-problem from a set of problem classes selected from the group consisting of: integer programming problems, mixed integer programming problems, optimization problems, simulation problems, constraint satisfaction problems, prediction modeling problems, k-SAT problems, and maximum independent set problems. Automatically routing the sub-problem to the at least one of the special-purpose computers in the network of special-purpose computers may include transmitting quantum information to the quantum computer. The method may further include transmitting quantum information between the at least two quantum computers.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a functional diagram of an embodiment of a computing system comprising a network of special-purpose computers.

FIG. 2 is a flow diagram that illustrates an embodiment of a method for using a network of specialized computers to solve a hard problem.

FIG. 3 is a functional block diagram of a networked computing system suitable for operating the methods for evaluating preferences in database queries, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with analog processors, such as quantum processors, quantum devices, coupling devices and control systems including microprocessors and drive circuitry have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The present systems, methods and apparatus describe a network of computers that includes special-purpose computers, where each special-purpose computer is designed to perform particularly well for at least one class of computation. In some embodiments, at least one of the computers is a quantum computer. In further embodiments, at least one quantum computer is a special-purpose quantum computer. A method for using the network of special-purpose computers includes subdividing a problem into a set of sub-problems, identifying the class of each sub-problem, and sending each sub-problem to an appropriate special-purpose computer that is designed to solve its corresponding problem class.

Many important problems contain within them at least one sub-problem that is difficult or intractable to solve given current computational technology. For example, the problem of breaking certain public-key cryptosystems can be decomposed into a series of sub-problems, one of which is the factorization of a product of large prime numbers. In the present systems, methods and apparatus, each sub-problem in the decomposition of the original problem may be computed by a computer that is specifically designed to handle the corresponding type of problem. In an exemplary embodiment, a network of special-purpose computers may include: one or more superconducting adiabatic quantum processors designed to handle combinatorial optimization problems, one or more ion trap quantum computers designed to handle simulation problems, one or more semiconductor-based quantum computers designed to handle factorization problems, one or more classical systems based on, for example, FPGA or ASICs designed for a specialized task (such as BLAST or differential equation solving), one or more analog computers such as a wind tunnel system designed to produce fluid dynamics calculations, and one or more conventional general-purpose computers. Those of skill in the art will appreciate that each special-purpose computer may be any form of computer including, but not limited to, the embodiments of quantum computers described in this specification. Furthermore, those of skill in the art will also appreciate that the specific type or types of problems that each special-purpose computer is designed to solve may depend on the particular physical realization of the special-purpose computer and its software and programming. For example, the embodiment described above uses one or more semiconductor-based quantum computers to handle factorization problems, but other embodiments may use one or more semiconductor-based quantum computers to handle simulation problems and/or one or more nuclear magnetic resonance quantum computers to handle factorization problems.

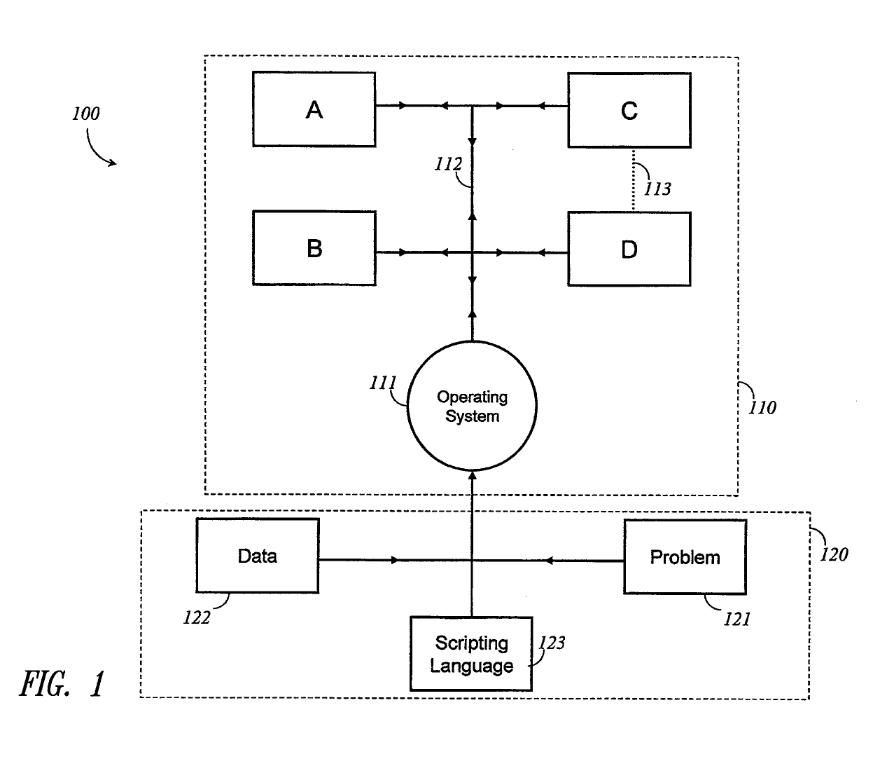

FIG. 1 is a functional diagram of an embodiment of a computing system 100 comprising a network of special-purpose computers 110. In this embodiment, network 110 includes four special-purpose computers A-D and one conventional general-purpose computer acting as the operating system 111. As previously discussed, those of skill in the art will appreciate that any number of special-purpose computers may be implemented in other embodiments of the present systems, methods and apparatus. Furthermore, operating system 111 may also function as a resource allocation tool and may comprise more than one conventional general-purpose computer.

Each of the four special-purpose computers A-D in the embodiment shown in FIG. 1 may be any form of special-purpose computer, including but not limited to the various embodiments of quantum computers described in this specification. For instance, in one embodiment special-purpose computers A-D may include a circuit model quantum dot quantum computer, an optical quantum computer, a superconducting quantum processor comprising charge qubits, and a superconducting quantum processor comprising flux qubits. In another embodiment special-purpose computers A-D may include a topological quantum computer, a classical computer system based on ASICs designed for solving differential equations, a wind tunnel system, and a nuclear magnetic resonance quantum computer. Those of skill in the art will appreciate that any number or combination of special-purpose computers may be implemented. Furthermore, the particular type or types of problems that each special-purpose computer is designed to solve may vary depending on the particular embodiment.

In FIG. 1, network 110 includes a network of communication conduits 112 (indicated by the solid lines with directional arrowheads). In this embodiment, operating system 111 communicates with each special-purpose computer A-D through network of communication conduits 112. Furthermore, special-purpose computers A-D may send return signals back to operating system 111. In some embodiments, any one of special-purpose computers A-D may also be in direct communication with any other one of special-purpose computers A-D through network of communication conduits 112. For example, in the illustrative embodiment of FIG. 1, special-purpose computer A is in direct communication with special-purpose computer C, and special-purpose computer B is in direct communication with special-purpose computer D. Depending on the nature of the special-purpose computers A-D being implemented, the communication conduits may take any of a variety of forms, including but not limited to: conventional electrical cables, printed circuit boards, superconducting wires, radio signals, single-flux quantum transmission lines, wi-fi, fiber-optic cables, qubit couplers, and the like. Those of skill in the art will appreciate that the terms “communication conduit” and “communication conduits” are used throughout this specification and the appended claims to include all manner of signal propagation and transfer.

A further aspect of the present systems, methods and apparatus is the incorporation of quantum communication within network 110. In embodiments in which at least one of special-purpose computers A-D is a quantum computer, communication with the quantum computer may include quantum communication through the transmission of quantum information. An example of a form of quantum communication that may be implemented is entanglement, which is well known in the art. For instance, entanglement is a studied form of quantum communication in EPR pairs. In some embodiments, it may be advantageous to establish quantum communication between at least two quantum computers in network 110. Such quantum communication is represented in FIG. 1 by dashed line 113 that connects special-purpose computers C and D. However, those of skill in the art will appreciate that similar quantum communication may be established between any pair and/or group of special-purpose computers depending on the particular embodiment, or such quantum communication may be omitted entirely if its inclusion provides no significant advantage. Every channel in a network of special-purpose computers, such as network 110, may be capable of exchanging quantum communication.

In some embodiments of the present systems, methods and apparatus, it may be advantageous to employ a fully interconnected network of special-purpose computers in which each special-purpose computer may communicate, either by classical or quantum means, or both, with every other special-purpose computer in the network.

In the embodiment shown in FIG. 1, information describing the problem is entered into operating system 111 through an input system 120. Input system 120 may comprise a user interface (not shown). In some embodiments, input system 120 may be contained, either completely or in part, within operating system 111. Through input system 120, the problem definition 121 and the problem data 122 may be converted into a programming language that can be interpreted by operating system 111. For instance, the problem definition 121 and the problem data 122 may be translated into a scripting language 123 which may be used by operating system 111 to allocate the various sub-problems resulting from the problem decomposition to the appropriate special-purpose computer A-D. Those of skill in the art will appreciate that another form of programming language other than a scripting language may similarly be used.

The present systems, methods and apparatus relate to the implementation of multiple specialized computers in the solving of a hard problem.

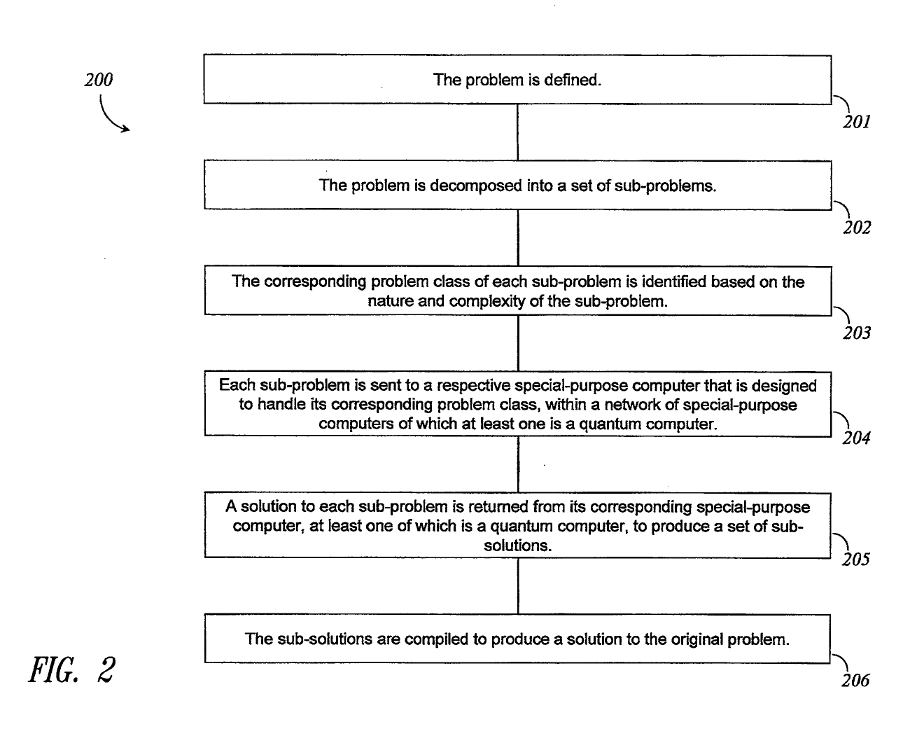

FIG. 2 is a flow diagram that illustrates an embodiment of a method 200 for using a network of specialized computers to solve a hard problem. In the embodiment shown in FIG. 2, method 200 comprises six acts 201-206. However, those of skill in the art will appreciate that in some embodiments certain acts may be omitted, additional acts may be included, or the acts may take place in a different order than that shown. Method 200 is drawn for illustrative purposes and is not meant to limit the present systems, methods and apparatus to the specific acts described therein.

In act 201, the problem is defined. This may be a problem that contains at least one sub-problem that is difficult to solve with conventional computer technology. In act 202, the problem is decomposed into a set of sub-problems. In some embodiments, this decomposition process may be designed to produce a set of sub-problems that efficiently uses the resources of a network of special-purpose computers. For instance, the forms of the sub-problems that are generated by the decomposition may be influenced by the computing resources available in a network of special-purpose computers. Alternatively, in some embodiments of the present systems, methods and apparatus the resources made available in the network of special-purpose computers may be influenced by the types of sub-problems that are to be solved. Many techniques for problem decomposition are well established in the art, including but not limited to: divide and conquer techniques and dynamic programming. For further detail on dynamic programming, see Cormen et al., Introduction to Algorithms, 2^{nd} Edition, The MIT Press (2003), pp. 323-369. Those of skill in the art will appreciate that any techniques for problem decomposition may be incorporated into the present systems, methods and apparatus to produce a set of sub-problems that may be solved with a network of special-purpose computers.

In act 203, each sub-problem is evaluated and its corresponding problem class is identified. Sub-problem classification may be based on the complexity class of the sub-problem and/or on the nature of the sub-problem and its corresponding data. Identification of each sub-problem class may be achieved by a computer algorithm or program which may or may not include input from a user. In act 204, each sub-problem is sent to a respective special-purpose computer that is designed to handle its corresponding problem class. The present systems, methods and apparatus include a network of special-purpose computers of which at least one is a quantum computer. Each computer in the network of special-purpose computers may be designed to handle a particular problem class, and thus in act 204 each sub-problem is sent to the appropriate special-purpose computer within the network of special-purpose computers. In act 205, a solution to each sub-problem is returned from its corresponding special-purpose computer to produce a set of sub-solutions. For some sub-problems, a special-purpose computer may return an approximate sub-solution. For other sub-problems, a special purpose computer may return an exact sub-solution. The nature of the sub-solutions returned by the special-purpose computers may depend on the nature of the sub-problems themselves, as well as on some predetermined sub-solution criteria. For instance, for some embodiments it may be advantageous to define a set of sub-solution criteria that describe at least one of: the desired accuracy of the sub-solution, the desired maximum computation time, the desired maximum number of iterations, and the like. In such embodiments, an approximate sub-solution may be returned for a sub-problem if at least one of the predetermined sub-solution criteria is met. In act 206, the sub-solutions are compiled to produce a solution to the original problem. The resulting solution to the original problem may similarly be an approximate solution or an exact solution depending on the nature of the problem itself.

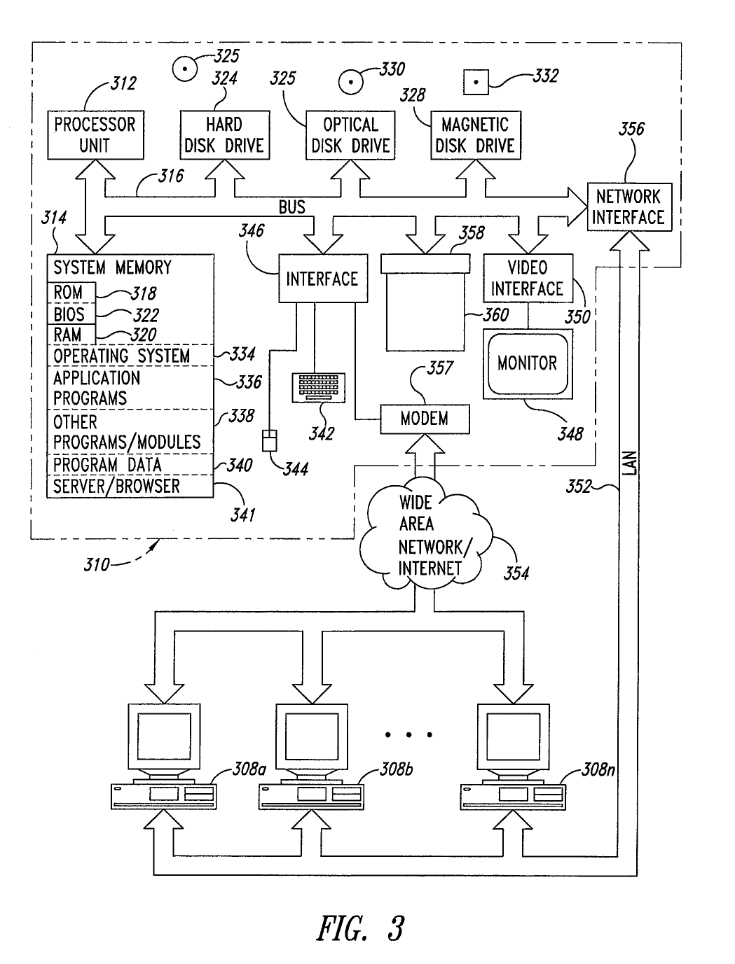

Throughout this specification and the appended claims, the terms “general-purpose computer” and “classical computer” are used to describe potential operating systems for the present systems, methods and apparatus. FIG. 3 shows a number of end user computing systems 308a-308n networked with a host computing system 310. The host computing system 310 may, for example, be operated by an application vendor, or an end user organization. The end user computing systems 308a-308n may, for example, be operated by one or more end users, such as employees of the end user organization. The end user computing systems 308a-308n may take the form of any of the variety of types discussed above, which may run a networking client, for example a Web browser. The host computing system 310 may take the form of any of the variety of types discussed above, which may run a networking client, for example a server. While the discussion immediately below is directed to the host computing system 310, many of the structures, functions and other aspects are relevant to the structure and operation of the end user computing systems 308a-308n, and thus will not be repeated in the interest of brevity and clarity.

The host computing system 310 includes a processor unit 312, a system memory 314 and one or more system buses 316 that couples various system components including the system memory 314 to the processor unit 312. The processor unit 312 may be any logical processor unit, such as one or more microcontrollers, central processor units (CPUs), microprocessors (e.g., CORE2 Extreme or DUO, PENTIUM or other processors available from INTEL; PowerPC or 68000 series processors available from MOTOROLA; OPTERON, ATHLON and other processors available from AMD), digital signal processors (DSPs) (e.g., MC56000 or TMS320 DSPs), application-specific integrated circuits (ASIC) (e.g., ASICs available from CHARTERED, CPACKETS, FIJITSU, IBM, INFINEON TECHNOLOGIES, MOSIS, NEC, SAMSUNG, OR TEXAS INSTRUMENTS), field programmable gate arrays (FPGAs) (e.g., VIRTEX, VIRTEX-II, VIRTEX-4, SPARTAN, XGC and other FPGAs available from XILINX; STRATIX and other FPGAs available from ALTERA; FPGAs available from LATTICE SEMICONDUCTOR, ACTEL, ATMEL, QUICKLOGIC, ACHRONIX SEMICONDUCTOR, MATH STAR) or hybrid devices (e.g., devices with processors embedded in FPGA's logic available from XILINX), etc. Unless described otherwise, the construction and operation of the various blocks shown in FIG. 3 are of conventional design. As a result, such blocks need not be described in further detail herein, as they will be understood by those skilled in the relevant art.

The system bus 316 can employ any known bus structures or architectures, including a memory bus with memory controller, a peripheral bus, and/or a local bus. The system bus 316 may, for example, include separate data, instruction and/or power buses. The system memory 314 may include read-only memory (“ROM”) 318 and random access memory (“RAM”) 320. A basic input/output system (“BIOS”) 322, which can form part of or be stored in the ROM 318, contains basic routines that help transfer information between elements within the host computing system 310, such as during startup.

The host computing system 310 also includes one or more spinning media memories such as a hard disk drive 324 for reading from and writing to a hard disk 325, and an optical disk drive 326 and a magnetic disk drive 328 for reading from and writing to removable optical disks 330 and magnetic disks 332, respectively. The optical disk 330 can be a CD-ROM, while the magnetic disk 332 can be a magnetic floppy disk or diskette. The hard disk drive 324, optical disk drive 326 and magnetic disk drive 328 communicate with the processor unit 312 via the bus 316. The hard disk drive 324, optical disk drive 326 and magnetic disk drive 328 may include interfaces or controllers coupled between such drives and the bus 316, as is known by those skilled in the relevant art, for example via an IDE (i.e., Integrated Drive Electronics) interface. The drives 324, 326 and 328, and their associated computer-readable media, provide nonvolatile storage of computer-readable instructions, data structures, program modules and other data for the host computing system 310. Although the depicted host computing system 310 employs hard disk 325, optical disk 330 and magnetic disk 332, those skilled in the relevant art will appreciate that other types of spinning media memory computer-readable media may be employed, such as, digital video disks (“DVD”), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 314, such as an operating system 334, one or more application programs 336, other programs or modules 338, and program data 340. The system memory 314 also includes a server 341 for permitting the host computing system 310 to exchange data with sources such as Websites of the Internet, corporate intranets, or other networks, as well as other server applications on server computers. The server 341 is markup language based, such as hypertext markup language (“HTML”), and operates with markup languages that use syntactically delimited characters added to the data of a document to represent the structure of the document. The server can perform one or more of a variety of functions, for example, taking the from of one or more of a file server, database server, backup server, print server, mail server, web server, FTP server, application server, VPN server, DHCP server, DNS server, WINS server, logon server, security server, domain controller, backup domain controller, proxy server, firewall, etc. Server 341 may, for example take the form of WINDOWS 2000 server available from MICROSOFT. The system memory 314 may also include a browser (e.g., INTERNET EXPLORER, or other browsers available from MICROSOFT, FIREFOX or other browsers available from MOZZILA, NAVIGATOR or other browsers available from NETSCAPE) or similar programs.

While shown in FIG. 3 as being stored in the system memory 314, the operating system 334, application programs 336, other program modules 338, program data 340 and server 341 can be stored on the hard disk 25 of the hard disk drive 324, the optical disk 330 and the optical disk drive 326 and/or the magnetic disk 332 of the magnetic disk drive 328. A user can enter commands and information to the host computing system 310 through input devices such as a keyboard 342 and a pointing device such as a mouse 344. Other input devices can include a microphone, joystick, game pad, scanner, etc. These and other input devices are connected to the processor unit 312 through an interface 346 such as a serial port interface that couples to the bus 316, although other interfaces such as a parallel port, a game port or a universal serial bus (“USB”) can be used. A monitor 348 or other display devices may be coupled to the bus 316 via video interface 350, such as a video adapter. The host computing system 310 can include other output devices such as speakers, printers, etc.

The host computing system 310 can operate in a networked environment using logical connections to one or more end user computing systems 308a-308n. The host computing system 310 may employ any known means of communications, such as through a local area network (“LAN”) 352 or a wide area network (“WAN”) such as the Internet 354. Such networking environments are well known in enterprise-wide computer networks, intranets, and the Internet.

When used in a LAN networking environment, the host computing system 310 is connected to the LAN 352 through an adapter or network interface 356 (communicatively linked to the bus 316). When used in a WAN networking environment, the host computing system 310 often includes a modem 357 or other device for establishing communications over the WAN/Internet 354. The modem 357 is shown in FIG. 3 as communicatively linked between the interface 346 and the WAN/Internet 354. In a networked environment, program modules, application programs, or data, or portions thereof, can be stored in a server computer (not shown). Those skilled in the relevant art will readily recognize that the network connections shown in FIG. 3 are only some examples of establishing communication links between host computing system 310 and end user computing systems 308a-308n, and other links may be used, including wireless links.

The host computing system 310 may include one or more interfaces such as slot 358 to allow the addition of devices either internally or externally to the host computing system 310. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory, collectively referenced as 360.

The term “computer-readable medium” as used herein refers to any medium that participates in providing instructions to processor unit 312 for execution. Such a medium may take many forms, including but not limited to, non-volatile media, volatile media, and transmission media. Non-volatile media includes, for example, hard, optical or magnetic disks 325, 330, 332, respectively. Volatile media includes dynamic memory, such as system memory 314. Transmission media includes coaxial cables, copper wire and fiber optics, including the wires that comprise system bus 316. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor unit 312 for execution. For example, the instructions may initially be carried on a magnetic disk of a remote computer. The remote computer can load the instructions into its dynamic memory and send the instructions over a telephone line using a modem. A modem 357 local to computer system 310 can receive the data on the telephone line and use an infrared transmitter to convert the data to an infrared signal. An infrared detector coupled to the system bus 316 can receive the data carried in the infrared signal and place the data on system bus 316. The system bus 316 carries the data to system memory 314, from which processor unit 312 retrieves and executes the instructions. The instructions received by system memory 314 may optionally be stored on storage device either before or after execution by processor unit 312.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to quantum computing algorithms or quantum computing systems, methods, and apparatus, not necessarily the exemplary quantum computing systems, methods, and apparatus generally described above.

The various embodiments described above can be combined to provide further embodiments. All of the US patents, US patent application publications, US patent applications, foreign patents, foreign patent applications and non-patent publications referred to in this specification and/or listed in the Application Data Sheet, including but not limited to U.S. Provisional Patent Application Ser. No. 60/971,502, filed Sep. 11, 2007, entitled “Systems, Methods, and Apparatus for a Distributed Network of Quantum Computers”, U.S. Pat. No. 6,838,694, U.S. Pat. No. 7,335,909, US Patent Publication Number 2006-0225165, U.S. patent application Ser. No. 12/013,192, U.S. Provisional Patent Application Ser. No. 60/986,554 filed Nov. 8, 2007, entitled “Systems, Devices and Methods for Analog Processing”, U.S. Provisional Patent Application Ser. No. 61/039,710, filed Mar. 26, 2008, entitled “Systems, Devices, And Methods For Analog Processing”, US Patent Publication Number 2006-0147154, and U.S. patent application Ser. No. 12/017,995 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computing system comprising:
an operating system including at least one classical computer;
a plurality of special-purpose computers of which at least one is a quantum computer; and
a communication network that includes a plurality of communication conduits wherein at least one communication conduit communicates between the operating system and at least one of the special-purpose computers.

2. The computing system of claim 1 wherein the quantum computer is selected from the group consisting of: an ion trap quantum computer, a quantum dot quantum computer, a nuclear magnetic resonance quantum computer, a semiconductor-based quantum computer, an optical quantum computer, a photonic quantum computer, a superconducting quantum computer, a circuit model quantum computer, an adiabatic quantum computer, a topological quantum computer, an anyon-based quantum computer, a quantum computer based on cavity quantum electrodynamic devices, a harmonic oscillator, and a cluster-state quantum computer.

3. The computing system of claim 2 wherein the quantum computer is a special-purpose quantum computer that solves a particular class of problems.

4. The computing system of claim 3 wherein the quantum computer solves problems from at least one problem class selected from the group consisting of: P problems, NP problems, NP-hard problems, NP-complete problems, QMA problems, QMA-complete problems, BQP problems, and QIP problems.

5. The computing system of claim 3 wherein the quantum computer solves problems from at least one problem class selected from the group consisting of: integer programming problems, mixed integer programming problems, optimization problems, simulation problems, constraint satisfaction problems, prediction modeling problems, k-SAT problems, and maximum independent set problems.

6. The computing system of claim 1 wherein at least one communication conduit is selected from the group consisting of: conventional electrical cables, printed circuit boards, superconducting wires, radio signals, single-flux quantum transmission lines, wi-fi, fiber-optic cables, and qubit couplers.

7. The computing system of claim 1 wherein at least one communication conduit communicates between at least two respective special-purpose computers.

8. The computing system of claim 1 wherein the communication network includes at least one quantum communication channel.

9. The computing system of claim 8 wherein the computing systems includes at least two quantum computers and the communication network includes at least one quantum communication channel between the at least two quantum computers.

10. The computing system of claim 8 wherein the at least one quantum communication channel supports a transmission of quantum information.

11. The computing system of claim 8 wherein the at least one quantum communication channel supports quantum communications via entanglement.

12. The computing system of claim 1 wherein at least one special-purpose computer is selected from the group consisting of: a classical special-purpose computer based on FPGA, a classical special-purpose computer based on ASICs, an analog computer, a wind tunnel system, and a conventional general-purpose computer.

13. A method of problem solving on a system of networked computers, the method comprising:
decomposing a problem into a set of sub-problems;
identifying a respective problem class of each sub-problem;
transmitting the set of sub-problems to a network of special-purpose computers that includes at least one quantum computer, wherein at least a first one of the special-purpose computers solves problems from at least a first one of the problem classes at least more effectively than at least a second one of the special-purpose computers in the network of special-purpose computers;
for each of at least some of the sub-problems in the set of sub-problems, routing the sub-problem to the at least one of the special-purpose computers in the network of special-purpose computers that is most effective at solving problems from the identified problem class to which the sub-problem belongs; and
for each of at least some of the sub-problems, solving the sub-problem on the special-purpose computer in the network of special-purpose computers to which the sub-problem was routed.

14. The method of claim 13 further comprising:
returning solutions to the sub-problems from the special-purpose computers to produce a set of sub-solutions; and
compiling the set of sub-solutions to produce at least an approximate solution to the problem.

15. The method of claim 13 wherein identifying a problem class of each sub-problem includes identifying the problem class of each sub-problem from a set of problem classes selected from the group consisting of: P problems, NP problems, NP-hard problems, NP-complete problems, QMA problems, QMA-complete problems, BQP problems, and QIP problems.

16. The method of claim 13 wherein identifying a problem class of each sub-problem includes identifying the problem class of each sub-problem from a set of problem classes selected from the group consisting of: integer programming problems, mixed integer programming problems, optimization problems, simulation problems, constraint satisfaction problems, prediction modeling problems, k-SAT problems, and maximum independent set problems.

17. The method of claim 13 wherein automatically routing the sub-problem to the at least one of the special-purpose computers in the network of special-purpose computers includes transmitting quantum information to the quantum computer.

18. The method of claim 13 wherein the network of special-purpose computers includes at least two quantum computers, and further comprising:
transmitting quantum information between the at least two quantum computers.
